(19) United States
(12) Patent Application Publication
(10) Pub. No.: US 2023/0268597 A1
(43) Pub. Date: Aug. 24, 2023

(54) HOUSING FOR ELECTRICAL POWER STORAGE DEVICE, ELECTRICAL POWER STORAGE DEVICE INCLUDING THE HOUSING, AND VEHICLE INCLUDING THE ELECTRICAL POWER STORAGE DEVICE

(71) Applicants: CPS Technology Holdings LLC, New York, NY (US); Clarios Germany GmbH & Co. KG, Hannover (DE)

(72) Inventors: Tyler Thiel, Germantown, WI (US); Arunraj Varatharajah, Menomonee Falls, WI (US); Rengaraj Balakrishnan, Cary, NC (US); Donald J. Caldwell, Milwaukee, WI (US); Jason D. Fuhr, Sussex, WI (US); Roderique Duell, Hannover (DE)

(21) Appl. No.: 18/020,398

(22) PCT Filed: Aug. 9, 2021
(86) PCT No.: PCT/US2021/045242

§ 371 Date: Feb. 8, 2023

Related U.S. Application Data
(60) Provisional application No. 63/063,795, filed on Aug. 10, 2020.
(60) Provisional application No. 63/191,673, filed on May 21, 2021.

(51) Int. Cl. H01M 50/244; B60K 1/04; H01M 50/249; H01M 50/296; H01M 50/552; H01M 50/55

(52) U.S. Cl. CPC H01M 50/244; B60K 1/04; H01M 50/249; H01M 50/296; H01M 50/552; H01M 50/55; H01M 2220/20; B60K 2001/0411; H01M 10/0525

(57) ABSTRACT

A housing for an electrical power storage device is described herein. The housing includes a compartment having a base, a first wall extending from the base, and a second wall extending from the base. The housing also includes a first apron portion and a second apron portion to be used as part of a hold-down assembly for holding down the housing. The first apron portion and the second apron portion are positioned on the first wall and the second wall, respectively, between 15% and 85% of a height of the first wail and second wall from the base to a top of the first wall and the second wall.

### CROSS-REFERENCE TO RELATED APPLICATIONS

This application claims the benefit of U.S. Provisional Patent Application No. 63/063,795, filed Aug. 10, 2020, entitled “HOUSING FOR ELECTRICAL POWER STORAGE DEVICE, ELECTRICAL POWER STORAGE DEVICE INCLUDING THE HOUSING, AND VEHICLE INCLUDING THE ELECTRICAL POWER STORAGE DEVICE,” and claims the benefit of U.S. Provisional Patent Application No. 63/191,673, filed May 21, 2021, entitled “BATTERY CONNECTOR AND BATTERY COVER,” the entire contents of each of which are hereby incorporated herein by reference for all purposes.

### BACKGROUND

The disclosure relates to an electrical power storage device, such as a lead-acid battery, having a hold-down assembly. Hold-down assemblies typically are on the battery casing and enable the battery to be connected to the vehicle using, for example, clamps.

Referring to FIGS. 1 and 2, an internal combustion engine 10 of a vehicle is shown. Also shown is a lead-acid battery 15 according to a construction of the prior art. The battery 15 is configured to provide at least a portion of the power to start or operate the vehicle and/or various vehicle systems. The vehicle may be one of a variety of types of vehicles including, among others, automobiles, motorcycles, buses, recreational vehicles, boats, and the like. The battery 15 includes a housing 20 having a box-like container (or compartment) 25 and can be made at least in part of a moldable resin.

For the construction shown in FIGS. 1 and 2, the compartment 25 includes aprons (aprons 30 and 35 are shown in FIG. 2) at the bottom of the front, rear, and side walls (walls 40 45 are shown in FIG. 2). A clamp (clamp 50 is shown in FIG. 1) couples to the aprons and holds the battery 15 in place. Placing the hold down assemblies at the bottom of a battery does not enable the most stable connection of the battery to a vehicle. For example, the vibration during operation of the car may affect a top of the battery more because the top of the battery is spaced further from the hold down assembly. Another mounting alternative to the hold-down assembly depicted in FIGS. 1 and 2 providing improved stabilization is desired.

Additionally, lead acid batteries typically have positive and negative terminals. The example terminals may be posts that are substantially cylindrical and extend above a top surface of a cover of the battery, or out the side of the battery container. In many applications, the terminals are connected to a device or machine (such as a vehicle) using a clamp-style connector. In some applications, the clamp style connector may rotate and/or slip on the terminal, which does not provide for a secure or stable connection. Additionally, any movement of the connector relative to the terminal may cause wear on the terminal and/or the clamp, which can eventually affect the performance of the connection between the battery and the connector.

### SUMMARY

A hold-down assembly for a battery is disclosed herein. The hold-down assembly, for at least one embodiment, comprises an apron in the middle of the battery's housing. Having the apron in the middle of the battery's housing limits the amount of housing that protrudes above a mounting platform for the battery. Also, the placing of the apron in the middle of the housing provides a more stable solution over the battery of the prior art.

In at least one embodiment, a housing for an electrical power storage device is disclosed. The housing comprises a compartment having a base, a first wall extending from the base, and a second wall extending from the base. The housing further comprises a first apron portion and a second apron portion to be used as part of a hold-down assembly for holding down the housing. The first apron portion and the second apron portion are disposed on the first wall and the second wall, respectively, between 15% and 85% of a height of the first wall and second wall from the base to a top of the first wall and the second wall.

In at least another embodiment, an electrical power storage device comprising the housing is disclosed. In yet at least another embodiment, a vehicle is disclosed. The vehicle comprises a mounting surface, the electrical power storage device, and a hold-down assembly comprising a hold down engaged with the first apron portion and the second apron portion.

Example terminals for a battery are described herein. The example terminals include one or more features that provide a more secure connection between a vehicle connector and the terminal than the traditional clamp-style connector. That is, the example terminals reduce or eliminate movement of the connector relative to the terminal, thereby reducing wear and increasing the performance of the connection.

In some examples, the terminals are a female-style terminal. In such examples, the terminals may include an annular ring or groove. On other such examples, the terminals may include a threaded portion. In other examples, the terminals may include one or more protrusions. Additionally, a portion of the cover adjacent to the terminal may have a keyed section to secure the connector.

These and various further advantages may be understood from the disclosure herein.

### BRIEF DESCRIPTION OF THE DRAWINGS

FIG. 1 is a perspective view of a representative prior electrical power storage device coupled to an internal combustion engine.

FIG. 2 is an isometric view of a battery capable of being used with the internal combustion engine of FIG. 1.

FIG. 3 is an example environment in which an electrical power storage device described herein may be used.

FIG. 4 is an isometric view of the electrical power storage device incorporating an aspect of the invention and being disposed with a mounting surface.

FIG. 5 is a first isometric view of a container of the electrical power storage device of FIG. 4.

FIG. 6 is a second isometric view of the container of the electrical power storage device of FIG. 4.

FIG. 7 is a third isometric view of the container of the electrical power storage device of FIG. 4.

FIG. 8 is a side view of the container of the electrical power storage device of the energy source of FIG. 4.

FIGS. 9 and 10 depict the example electrical power storage device with a first clamp that may be used to secure the electrical power storage device.

FIGS. 11 and 12 depict the example electrical power storage device with a first clamp that may be used to secure the electrical power storage device.

FIGS. 13-15 depict an alternative construction of the example electrical power storage device of FIG. 4, including female terminals.

FIG. 16 depicts a more detailed view of an example terminals, such as an example terminal of FIGS. 13-15.

FIG. 17 depicts a cross-sectional view of the example terminal of FIG. 16.

FIG. 18 depicts a more detailed view of an alternative construction of the example terminal, similar to the example terminal of one of FIGS. 13-15.

FIG. 19 depicts a cross-sectional view of the example terminal of FIG. 18.

FIGS. 20 and 21 depicts more detailed and cross-sectional views of an alternative construction of the example terminal, similar to the example terminal of one of FIGS. 13-15.

It should be understood that the drawings are not necessarily to scale. In certain instances, details that are not necessary to the understanding to the invention or render other details difficult to perceive may have been omitted. It should be understood, of course, that the invention is not necessarily limited to the apparatus or processes illustrated herein.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Referring to the Figures, an electrical power storage device 100 is disclosed, and in particular is a rechargeable battery, such as, for example, a lead-acid battery or a lithium-ion battery. According to one or more examples of embodiments, the electrical power storage device 100 is a lead-acid storage battery. Various embodiments of lead-acid storage batteries may be either sealed (e.g., maintenance-free) or unsealed (e.g., wet). According to one or more examples of embodiments, the lead-acid storage battery 100 is preferably a sealed lead-acid battery or AGM lead-acid battery and, to this end. While specific examples are described and illustrated, the battery 100 may be any secondary battery suitable for the purposes provided. A battery 100 is provided and shown in a vehicle 102 in FIG. 3.

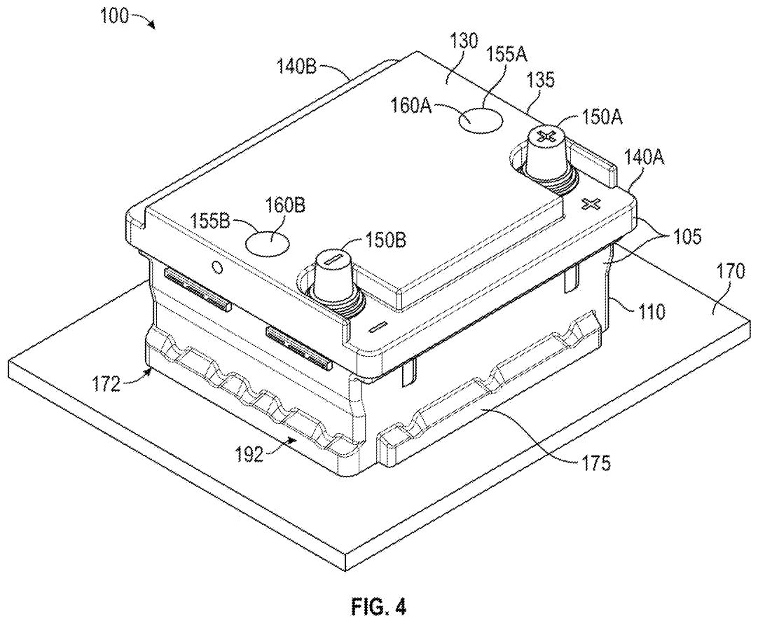

Referring to FIG. 4, an electrical power storage device 100 (e.g., a lead-acid battery) is shown. The electrical power storage device 100 can be used in one of a variety of types of vehicles including, among others, automobiles, motorcycles, buses, recreational vehicles, boats, and the like. The electrical power storage device 100 is configured to provide at least a portion of the power to start or operate the vehicle and/or various vehicle systems. Further, it should be understood that the electrical power storage device 100 may be utilized in a variety of applications not involving a vehicle, and such applications are intended to be within the scope of the present disclosure.

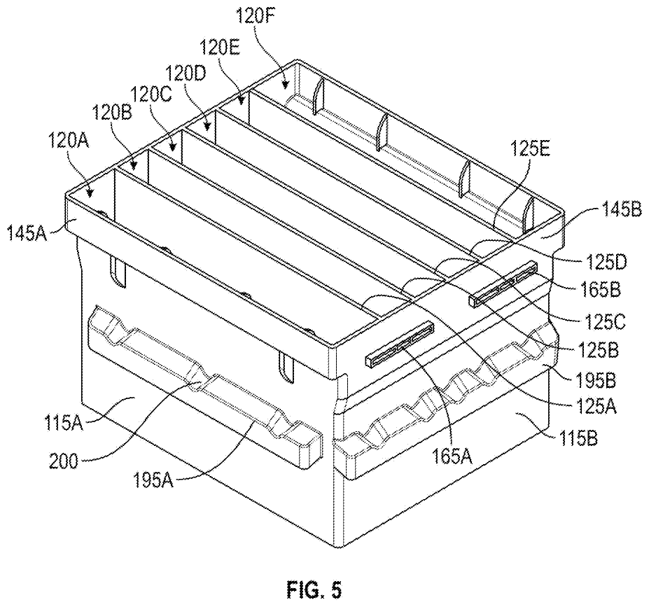

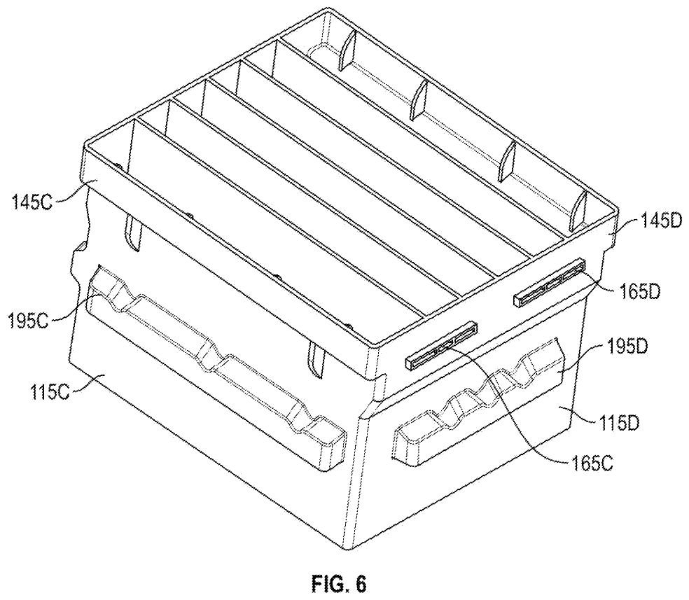

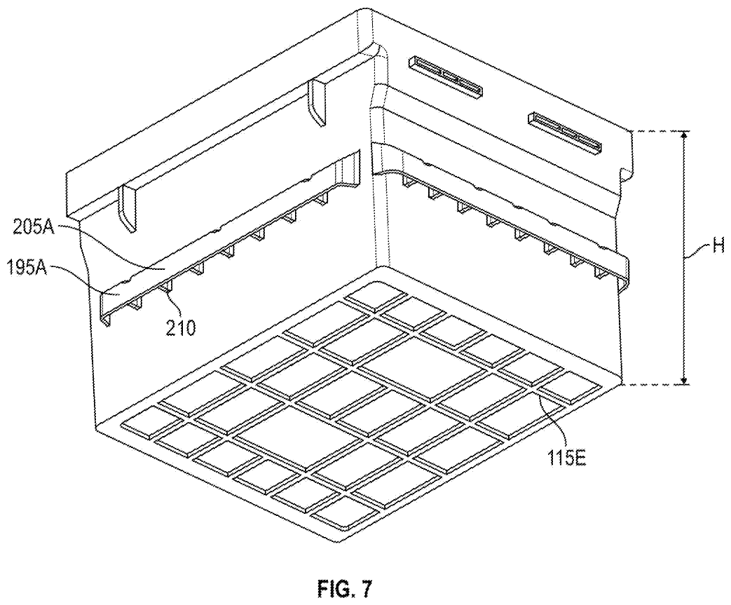

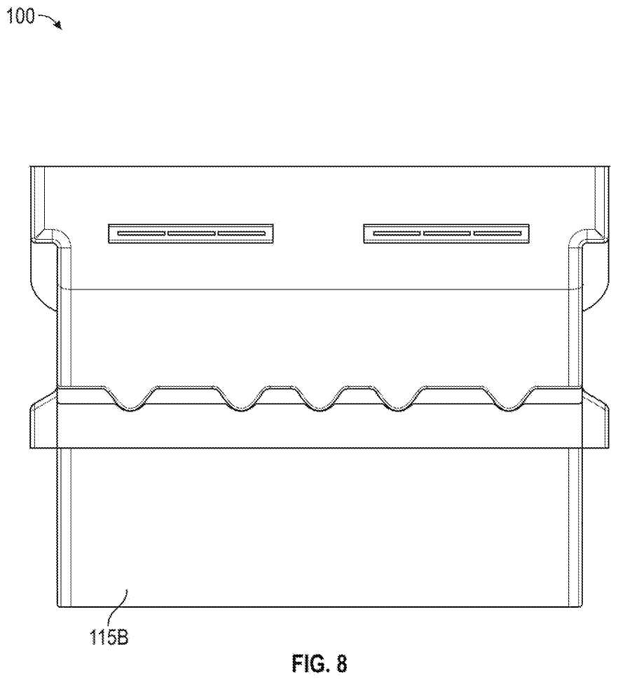

A housing (or case) 105 of an electrical power storage device 100 is shown. The housing 105 includes a box-like container (or compartment) 110 and can be made at least in part of a moldable resin. In various constructions, including the construction shown in FIGS. 5-8, container 110 has a plurality of walls 115A-E. The walls 115A-E can be referred to as first through fifth walls 115A-E, respectively.

In various constructions, including the construction shown in FIGS. 5-8, the interior of the container 110 includes six cell compartments 120A-F, which may be partitioned with five internal partitions 125A-E between the walls 115A and 115C. In other implementations, the number of partitions 125 and compartments 120 may vary to create electrical power storage devices with different voltages.

With reference to FIGS. 4-8, a cover (or lid) 130 is provided for the housing 105 and is coupled to the container 110. The cover 130 includes a wall 135 and projecting edges (edges 140A and 140B are shown) integral with the wall 135. For the shown construction, the projecting edges surround lips 145A-D of the walls 115A-D. The cover 130 includes terminals 150A and 150B and fill tubes 155A and 155B. The fill tubes 155A and 155B allow electrolyte to be added to the cells and to permit servicing. To prevent undesirable spillage of electrolyte from the fill tubes 155A and 155B and to permit exhausting of gases generated during the electrochemical reaction, the housing 105 may also include one or more filler hole caps 160A and 160B and vents 165A-D.

A positive terminal 150A and a negative terminal 150B may be found on one or more walls 115A-E and/or the cover 130 of the electrical power storage device 100. Such terminals 150A and 150B typically include portions which may extend through the cover 130 and/or a wall depending upon the electrical power storage device design. It will be recognized that a variety of terminal arrangements and designs are possible.

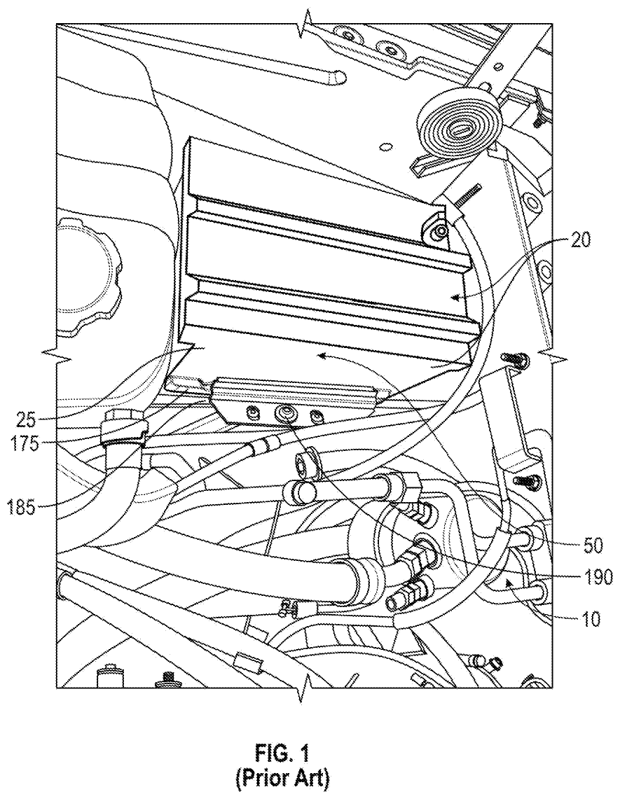

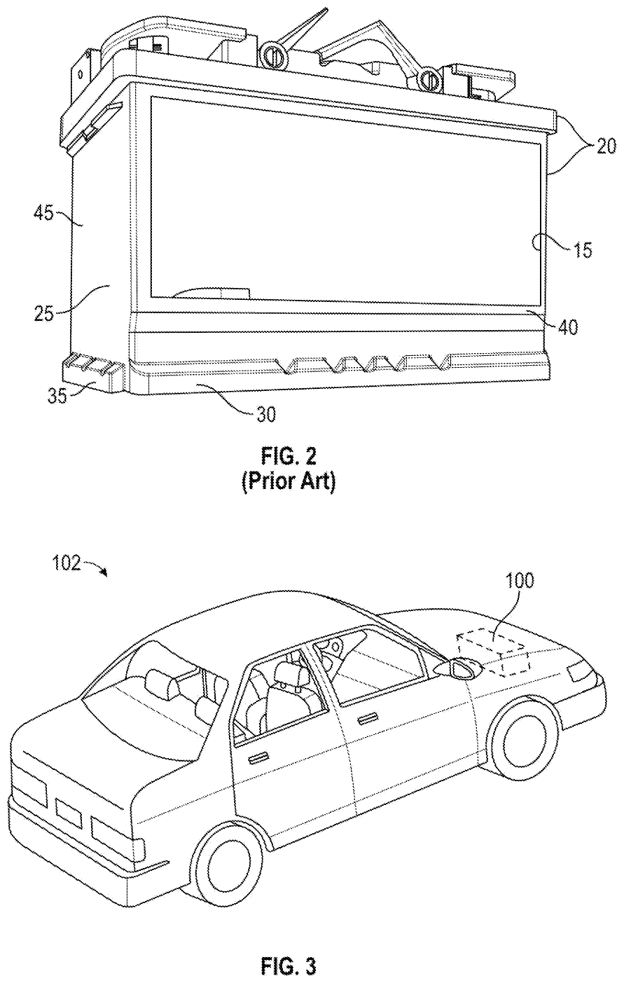

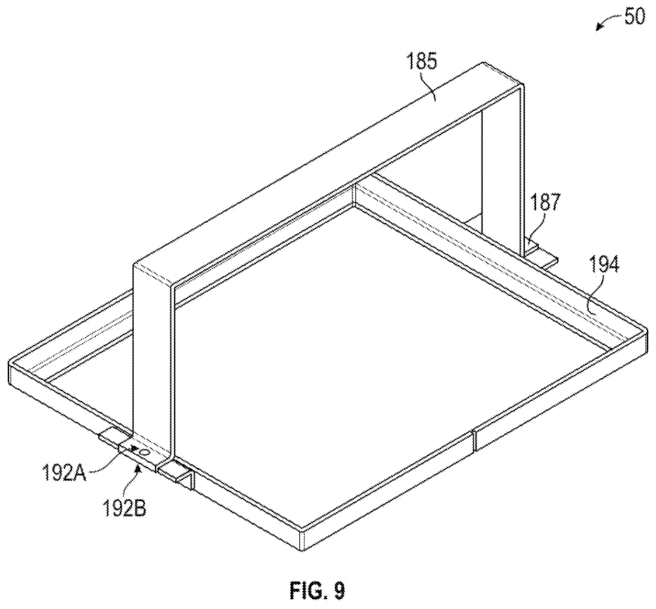

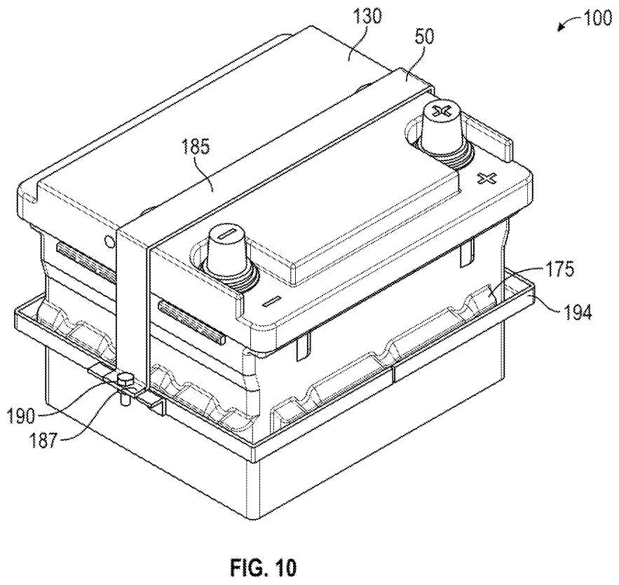

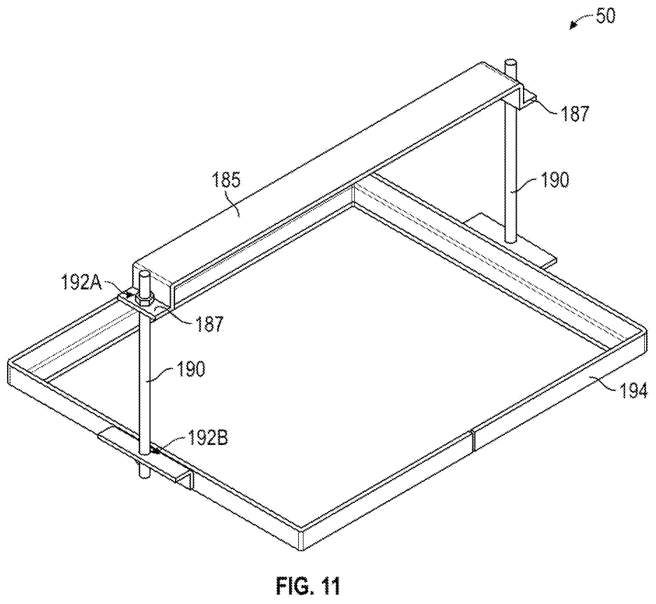

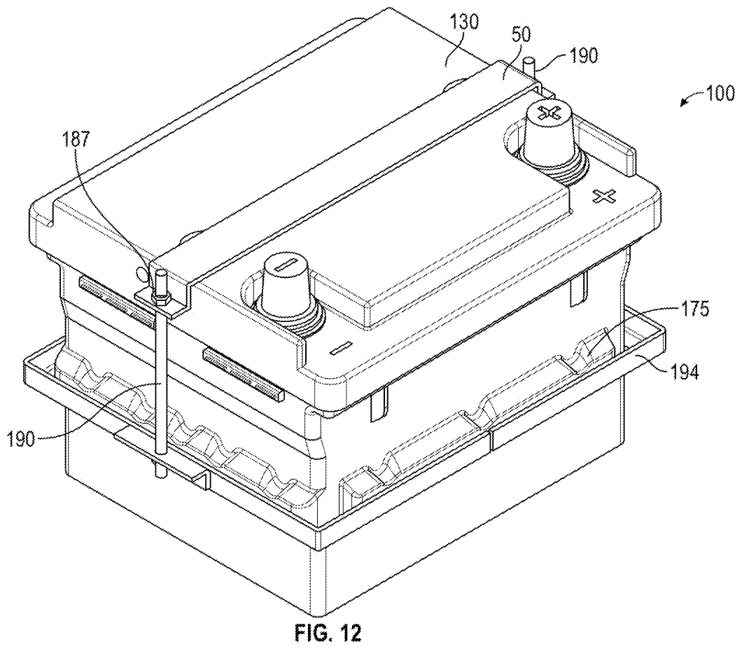

For the shown construction, the walls 115A-D can be referred to as side walls 115A-D, the wall 115E can be referred to as a base wall 115E, and the wall 135 can be referred to as a top wall (or cover wall) 135. The base wall (or simply base) 115 of the container 110 can be placed in or on a mounting surface (or tray) 170 (best shown in FIG. 3). The mounting surface 170 in FIG. 3 is exaggerated and includes an aperture 172. A hold-down assembly 175 can be similar to the hold-down assembly 175 shown in FIG. 1. The hold-down assembly 175 can be used to hold the electrical power storage device 100 in place. Referring to FIGS. 1 and 3, the hold-down assembly 175 can include a clamp 50 having a clamp bar 185, a bolt 190, an aperture 192, and a retaining mechanism (e.g., a washer and locking nut). Additionally, FIGS. 9-12 depict an example electrical power storage device with a clamp 50 that may be used with the example hold-down assembly 175. In some examples, the clamp 50 is a c-bracket type clamp, which includes a c-shaped clamping bar 185 and tabs 187 having apertures 192. The apertures 192A in the tabs 187 align with apertures 192B of a metal frame 194. Bolts 190 are positioned through the apertures 192A of the tabs 187 and the metal frame 194 to secure the electrical power storage device 100. The metal frame 194 may be integrated with or connected to the mounting surface 170. In some such examples, such as in the example construction depicted in FIGS. 9 and 10 sides of the c-shaped clamping bar 185 extend toward and contact the metal frame 194 such that the tabs 187 of the clamp 50 are in direct contact with the metal frame 194. Alternatively, such as in the example construction depicted in FIGS. 11 and 12, the sides of the c-shaped clamping bar 185 extend only partially toward the metal frame 194 such that the tabs 187 and the metal frame 194 are spaced apart. In such examples, the bolts are sized to extend between the tabs and the metal frame. Also included with the hold down-assembly 175 is an apron (discussed below). The design of the hold-down assembly can vary as known in the art.

Referring again to FIGS. 4-8, aprons 195A-D are integrally molded with the container 110. The aprons 195A-D can include a plurality of battery clamp mounting tabs (tab 200 is labelled) as in known in the art. For FIGS. 4-8, the shown aprons (e.g., apron 195A) include canopy portions (e.g., 205A) and support portions (e.g., support portion 210). The support portions 210 are shown as fins to help support the canopy portion 205. The canopy portions 205 includes the battery clamp mounting tabs. It is envisioned that other aprons and apron designs known in the art can be used in place of the shown apron, including the shown canopies and fins.

The side walls 115A-D of the container 110 have a height H defined from the base wall 115E to the top of the side walls 115A-D. Preferably, the apron 195 is at a position molded or fixed to the side walls 115A-D between 15% and 85% of the height H of the side walls 115A-D from the base wall 115E to the top of the side walls 115A-D. Accordingly, having the apron 195 between 15% and 85% of the height H of the side walls 115A-D limits the amount of housing 105 that protrudes above the mounting surface 170 for the electrical power storage device 100. Also, the placing of the apron between 15% and 85% of the height H of the side walls 115A-D provides a more stable solution over the battery of the prior art. In a more preferred implementation, the apron 195 is at a position molded or fixed to the side walls 115A-D between 15% and 75% of the height H of the side wall from the base wall 115E to the top of the side walls 115A-D. In a more preferred implementation, the apron 195 is at a position molded or fixed to the side walls 115A-D between 30% and 65% of the height H of the side wall from the base wall 115E to the top of the side walls 115A-D. In a more preferred implementation, the apron 195 is at a position molded or fixed to the side walls 115A-D between 40% and 60% of the height H of the side wall from the base wall 115E to the top of the side walls 115A-D.

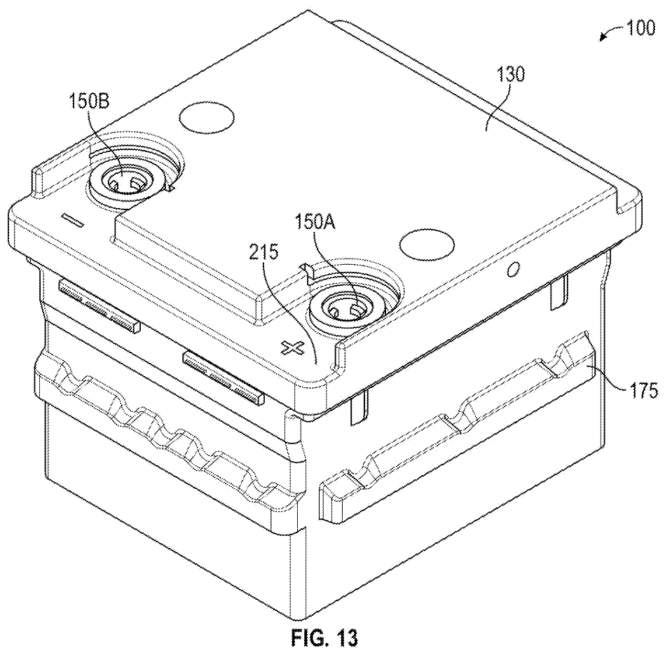

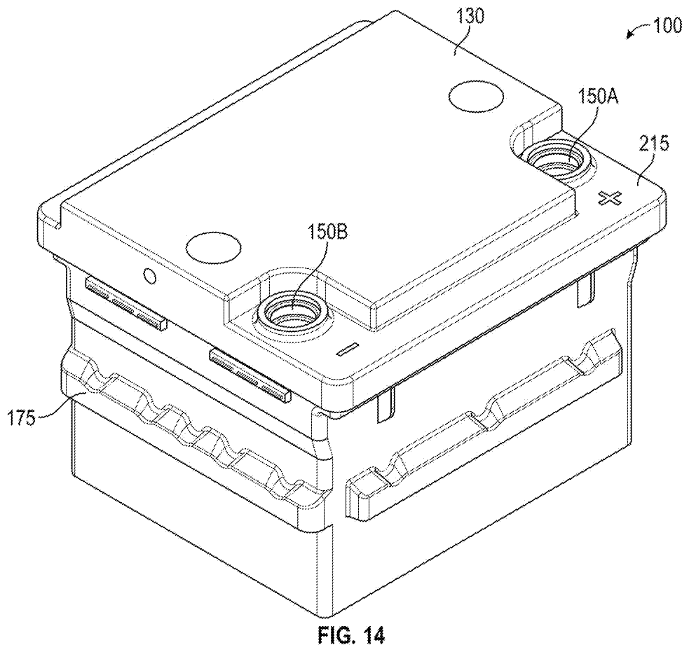

The example construction of the electrical power storage device of FIG. 4 also depicts example terminals 150A, 150B. The illustrated example, the terminals 150A, 150B are positioned on a portion 215 of the battery cover 130 that is indented (e.g., on a different plane) relative to a top surface 220 of the battery cover 130. Alternatively, the terminals 150A, 150B may be located on a side of the battery casing or housing. The example terminals 150A. 150B may be shaped such that only specific batteries or battery types can be used with certain connectors. The indented portion 215 may also have a shape that corresponds to a certain connector or type of connector. In some example constructions, such as the examples depicted in FIGS. 13-21, example terminals 150A, 150B are female connectors (e.g., receiving connectors, receptacles, sockets, slots, etc.), which allow for a threaded or keyed connection that is more secure than a typical clamp on a cylindrical terminal extending above a battery surface. For example, the constructions of the example terminals 150A, 150B described herein may decrease or prevent rotation of the connector coupled to the terminal 150A, 150B, which reduces wear on the terminal 150A, 150B in addition to providing a more secure connection to the terminal 150A, 150B.

FIGS. 13-15 depict example constructions of the electrical power storage device 100 with example female terminals 150A, 150B. The illustrated example electrical power storage device may be a lead acid battery including a positive terminal 150A and a negative terminal 150B. The example electrical power storage device 100 may be used with a vehicle 102 or may be used in another application. Alternatively, the electrical power storage device 100 having female terminals 150A, 105B may be a different type of battery chemistry (e.g., a lithium-ion battery) having a positive terminal and a negative terminal with a similar cover or container.

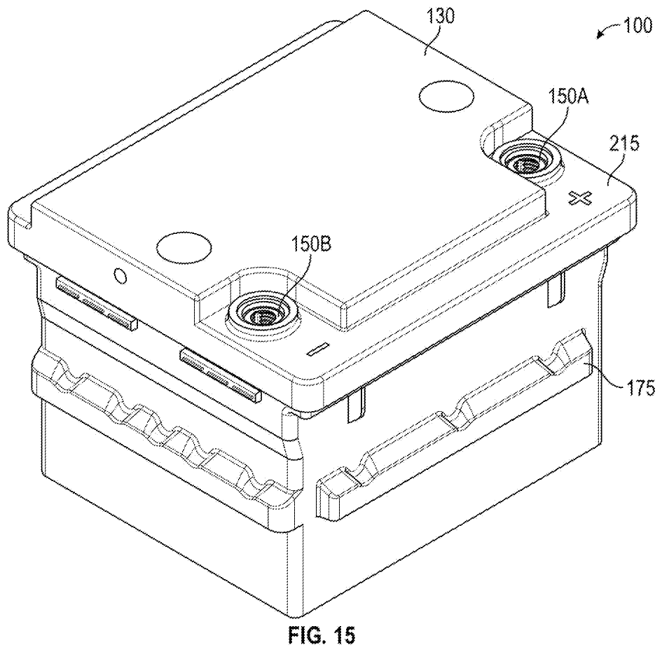

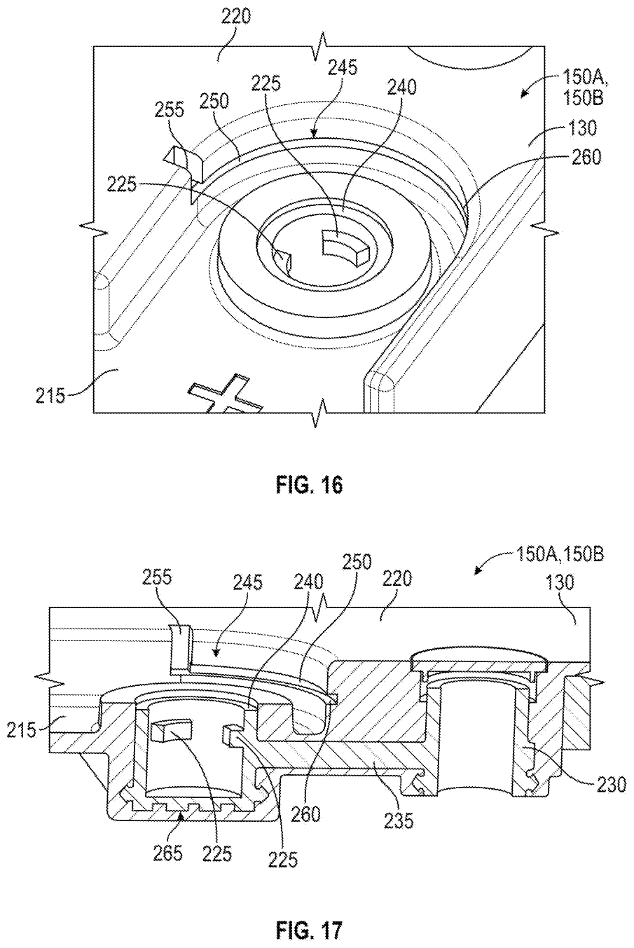

FIGS. 16 and 17 depict more detailed views of the example terminals 150A, 150B depicted in FIG. 4. FIG. 13-15 depicts a cross-sectional view of the example terminal 150A, 150B of FIG. 17. The example terminal 150A, 150B of FIGS. 16 and 17 is a female-type connection. The example terminal 150A, 150B may be made of a conductive lead-free material, such as aluminum, copper, steel, brass, etc. Using a lead-free material may result in a battery 100 with no exposed lead. A battery 100 without any exposed lead may have benefits (e.g., environmental benefits, health benefits) since there is no potential for lead exposure to the end customer.

In the illustrated construction of FIGS. 16 and 17, the terminal 150A, 150B includes protrusions 225 extending partially around an interior 230 of the terminal 150A, 150B. For example, the illustrated terminal 150A, 150B depicted in FIGS. 16 and 17 includes three evenly spaced protrusions 225 and each protrusion 225 extends approximately 60 degrees (e.g., one-sixth) around the inner circumference of the terminal 150A, 150B. The example protrusions 225 have squared edges, but any suitable shape, size, or number of protrusions may be used instead. In the illustrated example, the protrusions 225 are positioned closer to the top of the terminal 150A, 150B than the bottom surface of the terminal 150A, 150B, but are still spaced from the top edge. Alternatively, the protrusions 225 may be positioned in the middle of the wall of the terminal or closer to the bottom surface.

The example terminal of FIGS. 16 and 17 also includes a bushing sleeve 230 and conductive bridge 235, However, the terminal 150A, 150B of FIGS. 16 and 17 does not include a surrounding portion, so the material of the bushing sleeve 230 and conductive bridge 235 is the same as the terminal 150A, 150B. The terminal 150A, 150B may be lead or a lead-free metal (e.g., aluminum, steel, copper, brass, etc.).

As described above, the construction of the terminal 150A, 150B depicted in FIGS. 16 and 17 promotes a more secure connection between the terminal 150A, 150B and the connector. Additionally, the example terminal 150A, 150B of FIGS. 16 and 17 has a top edge 240 that is raised relative to the indented portion 215 of the cover 130. The cover 130 does not enclose the top edge 240 of the terminal 1150A, 150B in the illustrated example, but in other examples the cover 130 may enclose the top edge 240. Edges of the indented portion 215 are keyed 245 to securely connect the connector. In the illustrated examples, the keyed portion 245 includes one or more grooves 250 in the edges of the indented portion 215. Specifically, the groove 250 includes a vertical portion 255 and a horizontal portion 260 which may allow the connector to set down into the terminal 150A, 150B, then turn to lock into place. Additionally, a bottom of the surrounding portion of the terminal 150A, 150B may include a toothed portion 265 to prevent rotation or twisting of the terminal 150A, 150B.

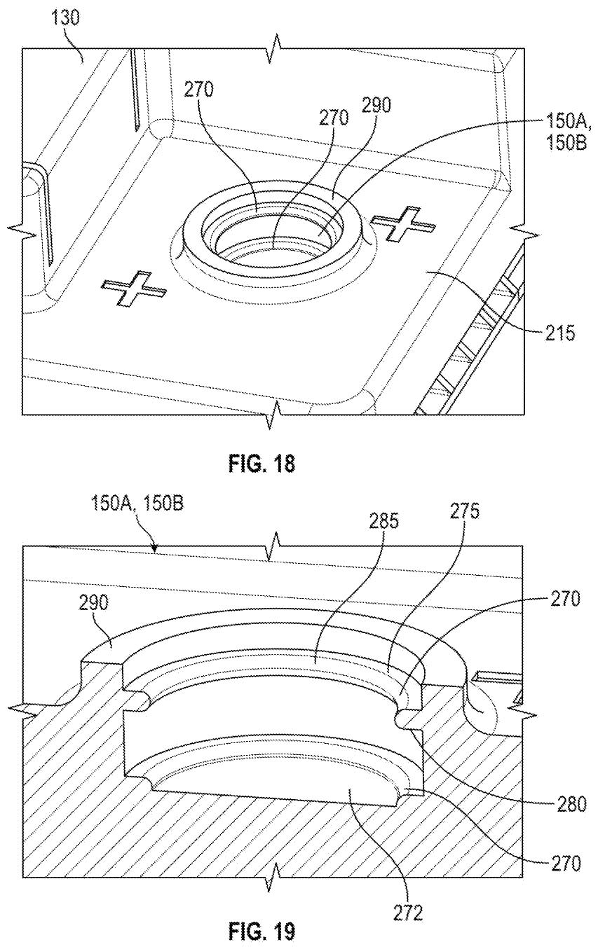

FIG. 18 depicts a more detailed view of an example terminal 150A, 150B, such as an example terminal 150A, 150B of one of FIGS. 13-15. FIG. 19 depicts a cross-sectional view of the example terminal 150A, 150B of FIG. 18. The example terminal 150A, 150B of FIGS. 18 and 19 is a female-type connection. The example terminal 150A, 150B may be made of a conductive lead-free material, such as aluminum, copper, steel, brass, etc. Using a lead-free material may result in a battery with no exposed lead. A battery without any exposed lead may have benefits (e.g., environmental benefits, health benefits) since there is no potential for lead exposure to the end customer. The example terminal 150A, 150B includes one or more annular rings 270, protrusions, or ribs to help hold a corresponding male-type connector (e.g., a plug, pin, prong, etc.) in place. For example, the corresponding connector may have annular grooves that are positioned or spaced on the connector to match up with the annular rings 270. Alternatively, the terminal may include an annular groove and the connector may include an annular ring.

In the illustrated example of FIGS. 18 and 19, the annular ring 270 has substantially flat upper and lower surfaces 275, 280 and a curved surface 285 extending between the upper and lower surfaces 275, 280. In the illustrated example, the lower surface 280 of one of the annular rings 270 is positioned flush with a bottom surface 272 of the terminal 150A, 150B. The annular ring(s) 270 may have any other suitable shape.

As described above in connection with FIGS. 13-15, the example terminal 150A, 150B is positioned on a portion 215 of the battery cover 130 that is indented relative to the top surface of the battery cover 130. The indented area 215 may be any suitable shape. In the illustrated examples of FIGS. 18 and 19, the indented portion 215 is square or rectangular. One or more corners may be rounded. In sonic examples, the terminal 150A, 150B may be off-center on the indented portion 215. In the illustrated example, a top edge 290 of the terminal 150A, 150B is raised relative to the indented portion 215 of the battery cover 130. Additionally, the illustrated top surface 290 is plastic and may be integral with the cover 130. Alternatively, the top edge 290 of the terminal may be flush with the indented portion 215 of the cover 130.

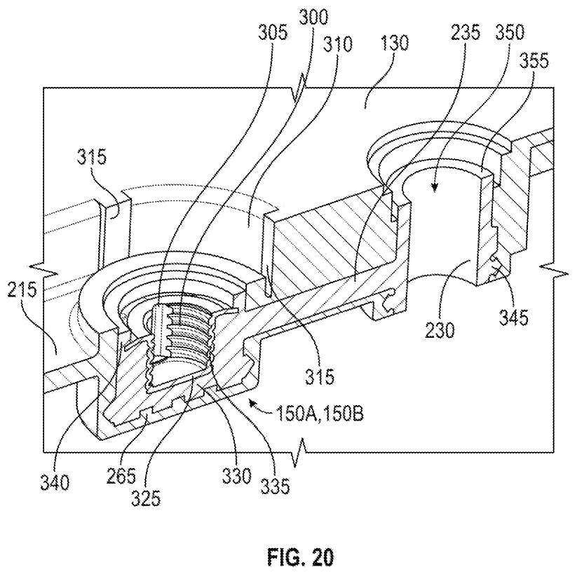

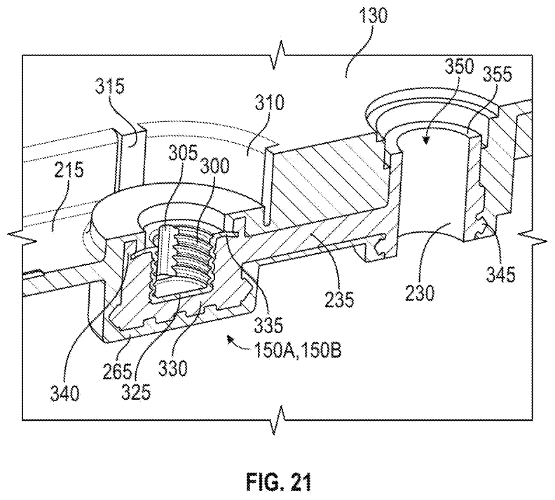

FIGS. 20 and 21 depict cross-sectional views of example terminals 150A, 150B, such as the example terminals 150A, 150B of any of FIGS. 13-15. The example terminals 150A, 150B of FIGS. 20 and 21 are threaded 300 to receive a threaded male connector. In some examples, the threaded portion 300 also includes a keyed section 305. The example indented area 215 adjacent to the terminals 150A, 150B of FIGS. 20 and 21 is substantially rectangular with a rounded edge 310, similar to the indented portions of FIGS. 13-15. In some examples, the edges 310 of the indented portions 215 may be keyed 315 to ensure a solid connection of the connector to the terminal 150A, 150B. In the illustrated examples, the keys 315 adjacent to the indented portions 215 include one or more protrusions from the edges 310 of the indented portions 215.

In the illustrated example terminal 150A, 150B of FIG. 20, the terminal 150A, 150B includes an interior portion 325 that is threaded 300 and a surrounding portion 330 connecting the interior portion 325 to the cover 130. In some examples, the interior portion 325 is a lead-free metal (e.g., a metal such as aluminum, steel, copper, brass, etc.). The top edge 335 of the interior portion 325 extends into the surrounding portion 330 adjacent to a top edge 340 of the surrounding portion. In some examples, the surrounding portion 330 may be lead, but in other examples the surrounding portion 330 is also a lead-free metal. The top edges 335, 340 of the interior portions 325 and the surrounding portions 330 are in a stepped configuration that is raised relative to the indented portion 215 of the battery cover 130. Additionally, a portion of the cover 130 surrounds the terminal 150A, 150B and extends above both the top edges 335, 340 of the interior portions 325 and the surrounding portion 330, but does not enclose the top edges 335, 340.

In the illustrated example terminal 150A, 150B of FIG. 21, the interior. portions 325 and surrounding portions 330 of the terminal 150A, 150B may have a configuration similar to that described in conjunction with FIG. 20. That is, the top edges 335, 340 may also be a stepped configuration that is raised relative to the indented portion 215 of the battery cover 130. The top edge 340 of the surrounding portion 330 of the example terminal 150A, 150B of FIG. 21 is enclosed in the plastic of the cover 130. Specifically, the edge 340 of the surrounding portion 330 that extends past the top edge 335 of the interior portion 325 is completely enclosed in the plastic of the cover 130. Thus, if the surrounding portion 330 is lead, the example terminal 150A, 150B depicted in FIG. 21 does not have any exposed lead.

FIGS. 20 and 21 also depict a bushing sleeve 230 that is electrically connected to the terminal 150A, 150B via a conductive bridge 235, similar to that shown in FIGS. 16 and 17. In the illustrated examples, the bushing sleeve 230, the conductive bridge 235, and the surrounding portion of the terminal 105A, 150B are the same material, which may be lead or a lead-free metal. The example bushing sleeve 230 and the surrounding portion may include one or more annular arrowhead-shaped features 345 to ensure a secure, leak-free construction in the battery cover 130. Additionally, a bottom of the surrounding portion of the terminal may include a toothed portion 265 to prevent rotation or twisting of the terminal 150A, 150B. The bushing sleeve 230 is to contact an internal post that is electrically connected to the electrodes of one or more cells in the battery. A cap or cover may be placed over the example opening 350 of the bushing sleeve 230, as depicted in FIGS. 13-15. The example cap or cover may include a groove corresponding to the top edge 355 of the bushing sleeve 230 that extends slightly above the lowest stepped portion of the battery cover 130 surrounding the bushing sleeve 230 so that the cap or cover is securely coupled to the opening 350 of the bushing sleeve 230. In some examples, a cover 130 having a bushing sleeve 203 and a conductive bridge 235 may be retrofit to a lead acid battery having a traditional terminal to enable a more secure connection between the terminals described herein and the connector and/or so that the battery does not have any exposed lead. A battery without any exposed lead may have benefits (e.g., environmental benefits, health benefits) since there is no potential for lead exposure to the end customer. Exposure to lead has many adverse side effects and the example battery without exposed lead eliminates the risk of lead exposure, which may cause those adverse side effects, for the consumer. Any lead surface exposed to the environment is a potential source of contamination. Thus, a battery without exposed lead is also beneficial for the environment.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further and unless explicitly noted, the terms and phrases used herein are not intended to be limiting but rather to provide an understandable description of possible implementations. Various implementations are shown in the drawings, but the implementations are not limited to the illustrated structure or application.

For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). The order or sequence of any process or method steps may be varied or re-sequenced according to alternative embodiments. Other substitutions, modifications, changes and omissions may be made in the design, operating conditions and arrangement of the various examples of embodiments without departing from the spirit or scope of the invention.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g. AB, AC, BC or ABC).

For the purpose of this disclosure, the term “coupled” means the joining of two members directly or indirectly to one another. Such joining may be stationary in nature or moveable in nature, Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

The terms fixedly, non-fixedly, and removably, and variations thereof, may be used herein. The term fix, and variations thereof, refer to making firm, stable, or stationary. It should be understood, though, that fixed doesn't necessarily mean permanent—rather, only that a significant or abnormal amount of work needs to be used to make unfixed. The term removably, and variations thereof, refer to readily changing the location, position, station. Removably is meant to be the antonym of fixedly herein. Alternatively, the term non-fixedly can be used to be the antonym of fixedly.

The technical effects and technical problems in the specification are exemplary and are not limiting. It should be noted that the embodiments described in the specification may have other technical effects and can solve other technical problems.

Aspects herein can be embodied in other forms without departing from the spirit or essential attributes thereof. Accordingly, reference should be made to the following claims, rather than to the foregoing specification, as indicating the scope hereof.

1. A housing for an electrical power storage device, the housing comprising:
a compartment having a base, a first wall extending from the base, and a second wall extending from the base; and
a hold down assembly apron coupled to the first and second walls, wherein the hold down assembly apron is positioned on the walls at a height between 15% and 85% of a total height of the first and second walls.

2. The housing of claim 1, wherein the hold down assembly apron includes a first apron portion and a second apron portion to be used as part of the hold down assembly apron for holding down the housing, the first apron portion and the second apron portion being disposed on the first wall and the second wall, respectively.

3. The housing of claim 2, wherein the first apron portion includes a first apron and the second apron portion includes a second apron.

4. The housing of claim 1, wherein the hold down assembly apron includes battery clamp mounting tabs.

5. The housing of claim 1, wherein the hold down assembly apron includes a canopy portion and fins to support the canopy portion.

6. The housing of claim 1 further comprising:
a cover;
a first terminal, wherein the first terminal is a female-style connector; and
a second terminal, wherein the second terminal is a female-style connector.

7. The housing of claim 6, wherein the first terminal and the second terminal include protrusions, wherein the protrusions are evenly spaced around each of the respective first and second terminals.

8. The housing of claim 6, wherein the first terminal and the second terminal include a threaded portion.

9. The housing of claim 6, further comprising a first groove positioned adjacent the first terminal and a second groove positioned adjacent the second terminal, the first and second grooves to enable a connection with a connector.

10. The housing of claim 6, wherein the first terminal and the second terminal include a keyed construction.

11. The housing of claim 6, wherein the first terminal and the second terminal include an annular ring.

12. The housing of claim 6, wherein the cover is configured to couple to the compartment and the first terminal and second terminal are positioned on a respective portion of the cover or on a side of the compartment.

13. An electrical power storage device comprising the housing of claim 1.

14. The electrical power storage device of claim 13, wherein the electrical power storage device is a lead acid battery.

15. The electrical power storage device of claim 13, wherein the electrical power storage device is a lithium-ion battery.

16. A vehicle comprising:
a mounting surface;
the electrical power storage device of claim 13; and
a hold-down assembly clamp comprising a hold down engaged with the hold down assembly apron.

17. A housing for a battery comprising:
a cover;
a container;
a first terminal, wherein the first terminal is a female-style connector; and
a second terminal, wherein the second terminal is a female-style connector.

18. The housing of claim 17, wherein the battery is a lead acid battery.

19. The housing of claim 17, wherein the battery is a lithium-ion battery.

20. The housing of claim 17, wherein the first terminal and the second terminal include a threaded portion.

21. The housing of claim 17, further comprising a first groove positioned adjacent the first terminal and a second groove positioned adjacent the second terminal, the first and second grooves to enable a connection with a connector.

22. The housing of claim 17, wherein the first terminal and the second terminal include a keyed construction.

23. The housing of claim 17 wherein the first terminal and the second terminal include protrusions, wherein the protrusions are evenly spaced around each of the respective first and second terminals.

24. The housing of claim 17, wherein the first terminal and the second terminal include an annular ring.
